(19) United States
(12) Patent Application Publication
(10) Pub. No.: US 2007/0086448 A1
(43) Pub. Date: Apr. 19, 2007

(54) Integrated pseudo-wire and virtual routing and forwarding on a single provider edge router

(75) Inventor: Cheng-Hong Hu, San Ramon, CA (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/252,098

(22) Filed: Oct. 17, 2005

(51) Int. Cl. H04L 12/56

(52) U.S. Cl. 370/389; 370/401

(57) ABSTRACT

A Pseudo-Wire to Virtual Private Network Provider Edge (PW-VPN PE) router (300) has a pseudo-wire (PW) element (302), a virtual routing and forwarding (VRF) element (304) integrally coupled to the PW element, and a controller (306) for controlling operations of the PW and the VRF elements. The controller is programmed to receive (408-414) a layer 3 (L3) packet comprising a frame and an embedded L3 packet, and transmit (416) to a targeted network element on a virtual circuit a new frame with the embedded L3 packet.

### FIELD OF THE DISCLOSURE

The present disclosure relates generally to provider edge (PE) routers, and more specifically to an integrated pseudo-wire and virtual routing and forwarding on a single provider edge router.

### BACKGROUND

It has become common practice for telecommunications service providers to combine legacy layer 2 (L2) networks such as Asynchronous Transfer Mode Frame Relay (ATM/FR) networks with layer 3 (L3) networks such as Internet Protocol (IP)/VPN (Virtual Private Networks) and/or Multi-Protocol Label Switching (MPLS)/VPN networks. To do so, prior art systems have utilized a technique for transporting L2 packet traffic on L3 networks according to a method commonly referred to as pseudo-wire transport.

FIGS. 1 and 2 illustrate prior art systems for transporting L2 traffic over an L3 backbone network. In FIG. 1, a VPN customer coupled to, for example, Customer Edge router 1 (CE1) can access IP/VPN services through an L2 access network employing, for example, ATM/FR switching technology. Provider Edge router 1 (PE 1) establishes pseudo wires (i.e., L2 traffic over an L3 transport) with the L2 access network. This traffic is intercepted by PE 2, which provides L3 services in an IP/VPN network coupled to other CE routers. In this prior art system, PEs 1 and 2 are interconnected by way of a physical coupling, which can be susceptible to a single-point failure that can render end-to-end communications inoperable.

The prior art system of FIG. 2 makes an improvement over the prior art system of FIG. 1 by integrating PE 1 and PE 2 routers into a single unit, thereby reducing cost. This integrated unit has a pseudo-wire (PW) element coupled by an external physical connection to a Virtual Routing and Forwarding (VRF) element that connects to a customer's VPN network. The PW element creates pseudo-wire connections with the L2 access network, and transports traffic therefrom through the VRF element, which in turn reformats the traffic for transport in an IP/VPN network. The physical coupling between the PW and VRF elements is on the same PE router. The solution of FIG. 2 thus reduces the equipment cost by nearly half of the prior art system of FIG. 1, and helps to minimize the single point failure described earlier. However, two extra L2 ports are required to connect L2 and L3 functions together on the same PE router.

### BRIEF DESCRIPTION OF THE DRAWINGS

FIGS. 1-2 are block diagrams of prior art pseudo-wire provider edge (PE) routers;

FIG. 3 is block diagram of a Pseudo-Wire to IP Virtual Private Network Provider Edge (PW-IP/VPN PE) router integrating teachings of the present disclosure;

FIG. 4 depicts a flowchart of a method operating in the PW-IP/VPN PE router integrating teachings of the present disclosure; and

FIG. 5 is a diagrammatic representation of a machine in the form of a computer system within which a set of instructions, when executed, may cause the machine to perform any one or more of the methodologies discussed herein.

### DETAILED DESCRIPTION OF THE DRAWINGS

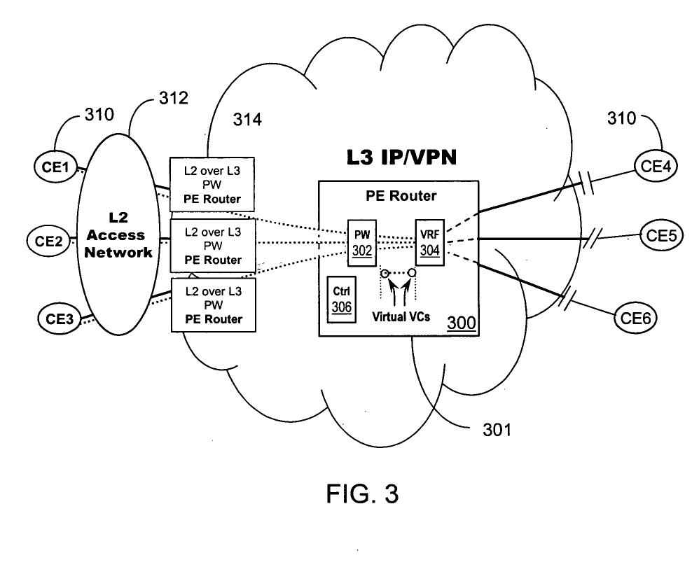

FIG. 3 is block diagram of a Pseudo-Wire to IP Virtual Private Network Provider Edge (PW-IP/VPN PE) router 300 integrating teachings of the present disclosure. The PW-IP/VPN PE router 300 comprises a pseudo-wire (PW) element 302 and a Virtual Routing and Forwarding (VRF) element 304 integrally coupled to each other by way of a virtual circuit. The PW-IP/VPN PE router 300 further comprises a controller 306 for controlling operations of the PW element 302 and VRF element 304. The PW-IP/VPN PE router 300 has a housing assembly 301 for carrying the aforementioned components. The virtual circuit between PW element 302 and the VRF element 304 can be an unexposed physical connection such as a dedicated signal bus, an unexposed logical connection such as software processes operating between the PW and VRF elements, or combinations thereof.

The PW element 302 utilizes common technology for processing packet streams exchanged on a pseudo-wire. A pseudo-wire is an emulation of a native service over a Packet Switched Network (PSN). The native service may be ATM, Frame Relay, Ethernet, low-rate TDM (Time Division Multiplexing), or SONET SDH (Synchronous Digital Hierarchy), while the PSN may be MPLS, or IP (either IPv4 or IPv6). The VRF element 304 utilizes common IP/VPN (or MPLS/VPN) technology for transporting traffic on virtual private networks (VPNs). A VPN is a private data network that makes use of the public telecommunication infrastructure, and maintains privacy through the use of a tunneling protocol to separate the customers' networks. The controller 302 comprises computing technology such as a microprocessor, DSP (Digital Signal Processor) and associated mass storage media such as a disk drive, random access memory, flash memory, or other storage devices. The controller 302 can also be represented by a desktop computer, server or other processing device that can perform the operations disclosed herein.

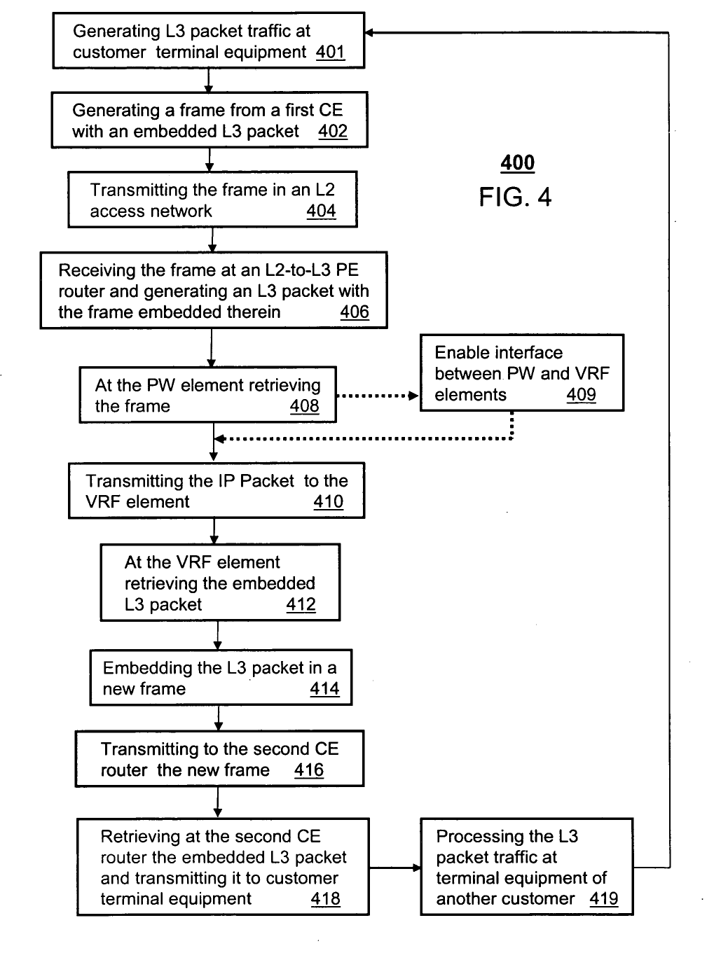

The PW-IP/VPN PE router 300 is coupled to customer edge (CE) routers 310, a conventional an L2 access network 312, such as an ATM/FR network, and conventional L2-to-L3 PE routers 314. The function and operation of these components is illustrated in FIG. 4, which depicts a flowchart of a method 400 operating in the PW-IP/VPN PE router 300 according to the teachings of the present disclosure. Method 400 provides an overview of communications between first and second CE routers 310 each supporting one or more users with terminal equipment (e.g., desktop computer) coupled thereto.

Method 400 begins with step 401 where L3 packet traffic at terminal equipment of a customer is generated. This traffic can be as simple as a file transfer or more sophisticated functions such as video and/or voice over IP traffic. This traffic is generally destined for terminal equipment of another customer. In step 402, a first CE router 310 intercepts the traffic generated in step 401, and generates by conventional means a frame with an embedded L3 packet carrying a portion of said traffic. A frame is a packet defined by the second layer of the well-known OSI (Open Systems Interconnection) model. An L3 packet can be a packet that complies with standards such as the Multi-Protocol Label Switching (MPLS) or the Internet Protocol (IP). For illustration purposes only, the L3 packets will be referred to from hereon as IP packets.

In step 404, the first CE router 310 transmits the frame in the L2 access network 312, which in turn relays the frame to a select one of the conventional L2-L3 PE routers 314. The L2-L3 PE router 314 in step 406 receives the frame and embeds the frame in an IP packet. The IP packet is intercepted by the PW element 302 of the PW-IP/VPN PE router 300. The PW element 302 retrieves in step 408 the frame from the IP packet, and transmits it in step 410 to the VRF element 304.

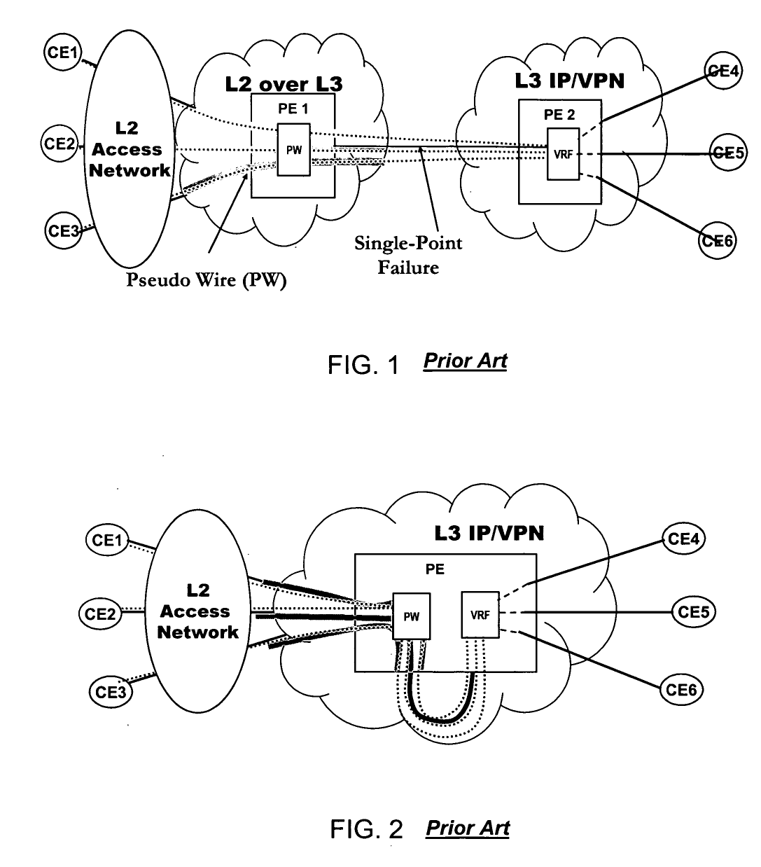

The transmission step can be accomplished in step 409 by enabling a virtual circuit such as a physical and/or logical interface that interconnects the PW element 302 and the VRF element 304 (e.g., a physical signal bus and/or software bus). For any of these embodiments, the housing assembly 301 of the PW-VRF PE router 300 protects exchanges between the PW element 302 and the VRF element 304 from physical or other impairments (such as cross-talk), thus making it improbable that a single-point of failure such as described in the prior art systems of FIGS. 1 and 2 will occur. Said housing assembly 301 also eliminates the need for two extra L2 ports to connect L2 and L3 functions together as shown in the prior art system FIG. 2.

In step 412, the VRF element 412 retrieves the embedded IP packet from the frame. The VRF element 304 in step 414 embeds the retrieved IP packet in a new frame, which it transmits in step 416 to the second CE router 310. The CE router 310 in step 418 retrieves the embedded IP packet from the new frame, and transmits it to terminal equipment of a targeted customer coupled to the second CE router 310. In step 419 the IP packet is processed at the terminal equipment of the said customer.

The foregoing description traces a single packet from one customer to another targeted customer. It would be apparent to those of ordinary skill in the art that steps 401through 419 can be repeated for transporting packet traffic between customers. Additionally, said steps can be used for engaging in bidirectional communications in an IP/VPN connection or MPLS/VPN connection between customers coupled to the CE routers 310.

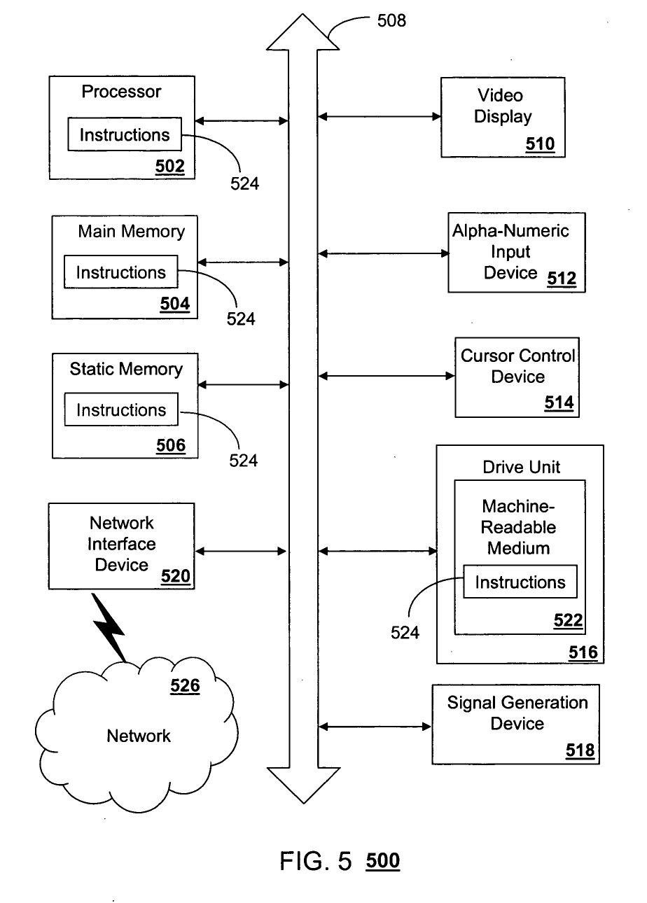

FIG. 5 is a diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated in herein above. The instructions 524 may also reside, completely or at least partially, within the main memory 504, the static memory 506, and/or within the processor 502 during execution thereof by the computer system 500. The main memory 504 and the processor 502 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A Pseudo-Wire to Virtual Private Network Provider Edge (PW-VPN PE) router, comprising:
a pseudo-wire (PW) element;
a virtual routing and forwarding (VRF) element integrally coupled to the PW element; and
a controller for managing operations of the PW element and VRF element, and programmed to to:
receive a layer 3 (L3) packet comprising a frame and an embedded L3 packet; and
transmit to a targeted network element a new frame with the embedded L3 packet.

2. The PW- VPN PE router of claim 1, wherein the controller is programmed to:
cause the PW element to:
retrieve the frame from the L3 packet; and
transmit the frame on the integral connection to the VRF element;
cause the VRF element to:
retrieve the embedded L3 packet from the frame;
embed the L3 packet in the new frame; and
transmit the new frame to the targeted network element.

3. The PW-VPN PE router of claim 1, wherein the L3 packet is compliant with Internet Protocol (IP).

4. The PW- VPN PE router of claim 1, wherein the L3 packet is compliant with Multi-Protocol Label Switching (MPLS).

5. The PW-VPN PE router of claim 1, wherein the controller is programmed to exchange data in an IP/VPN connection between customer edge (CE) routers.

6. The PW-VPN PE router of claim 1, wherein the controller is programmed to exchange data an MPLS/VPN connection between CE routers.

7. The PW-VPN PE router of claim 1, comprising a housing assembly for carrying the components of the PW-VPN PE router, and wherein the integral connection comprises at least one among an unexposed physical interconnection and a logical interconnection between the PW element and the VRF element.

8. A computer-readable storage medium, comprising computer instructions for:
enabling an integral connection between a pseudo-wire (PW) element and a virtual routing and forwarding (VRF) element, wherein each of the PW element and VRF element has computer instructions for:
receiving an L3 packet comprising a frame and an embedded L3 packet; and
transmitting to a CE router a new frame with the embedded L3 packet.

9. The storage medium of claim 8, wherein the L3 packet is a packet compliant with the Internet Protocol (IP), and wherein the storage medium comprises computer instructions for:
retrieving the frame from the IP packet;
transmitting the frame on the integral connection to the VRF element;
retrieving the embedded IP packet from the frame;
embedding the IP packet in the new frame; and
transmitting the new frame to the CE router.

10. The storage medium of claim 8, wherein the L3 packet is a packet compliant with Multi-Protocol Label Switching (MPLS), and wherein the storage medium comprises computer instructions for:
retrieving the frame from the MPLS packet;
transmitting the frame on the integral connection to the VRF element;
retrieving the embedded MPLS packet from the frame;
embedding the MPLS packet in the new frame; and
transmitting the new frame to the CE router.

11. The storage medium of claim 8, comprising computer instructions for exchanging data in an IP/VPN (Virtual Private Network) connection between customer edge (CE) routers.

12. The storage medium of claim 8, comprising computer instructions for exchanging data in an MPLS/VPN connection between CE routers.

13. A method, comprising the steps of:
enabling an unexposed physical connection between a pseudo-wire (PW) element and a virtual routing and forwarding (VRF) element;
receiving at a pseudo-wire (PW) element from an L2 to L3 PE router an L3 packet comprising a frame and an embedded L3 packet from a first customer edge (CE) router; and
transmitting from the VRF element to a second CE router a new frame with the embedded L3 packet.

14. The method of claim 13, wherein the L3 packet is a packet compliant with the Internet Protocol (IP), and wherein the method comprises the steps of:
retrieving the frame from the IP packet;
transmitting the frame on the integral connection to the VRF element;
retrieving the embedded IP packet from the frame;
embedding the IP packet in the new frame; and
transmitting the new frame to the second CE router.

15. The method of claim 13, wherein the L3 packet is a packet compliant with Multi-Protocol Label Switching (MPLS), and wherein the method comprises the steps of:
retrieving the frame from the MPLS packet;
transmitting the frame on the integral connection to the VRF element;
retrieving the embedded MPLS packet from the frame;
embedding the MPLS packet in the new frame; and
transmitting the new frame to the second CE router.

16. The method of claim 13, comprising the step of exchanging data in an IP/VPN (Virtual Private Network) connection between the first and second CE routers.

17. The method of claim 13, comprising the step of exchanging data in an MPLS/VPN connection between the first and second CE routers.

18. A method, comprising the steps of:
generating an L3 packet at terminal equipment of a customer coupled to a first CE router;
generating a frame at the first CE router destined for a second CE router, wherein the frame embeds the L3 packet generated by the terminal equipment;
transmitting the frame in a L2 access network;
receiving the frame at an L2-to-L3 PE router;
generating at the L2-to-L3 PE router an L3 packet comprising the frame;
receiving the L3 packet at a PW-VPN PE router comprising a pseudo-wire (PW) element and a virtual routing and forwarding (VRF) element integrally coupled to each other by way of a virtual circuit;
transmitting from the PW-VPN PE router a new frame with the embedded L3 packet destined for the second CE router;
retrieving at the second CE router the embedded L3 packet from the new frame; and
transmitting from the second CE router the embedded L3 packet to terminal equipment of another customer coupled to the second CE router; and
processing the L3 packet at the terminal equipment of the other customer.

19. The method of claim 18, wherein the L3 packet is a packet compliant with the Internet Protocol (IP), and wherein the PW-VPN PE router the method comprises the steps of:
retrieving the frame from the IP packet;
transmitting the frame on the integral connection to the VRF element;
retrieving the embedded IP packet from the frame;
embedding the IP packet in the new frame; and
transmitting the new frame to the second CE router.

20. The method of claim 18, wherein the L3 packet is a packet compliant with Multi-Protocol Label Switching (MPLS), and wherein PW-VPN PE router the method comprises the steps of:
retrieving the frame from the MPLS packet;
transmitting the frame on the integral connection to the VRF element;
retrieving the embedded MPLS packet from the frame;
embedding the MPLS packet in the new frame; and
transmitting the new frame to the second CE router.
